(19) United States
(12) Patent Application Publication
(10) Pub. No.: US 2018/0317014 A1
(43) Pub. Date: Nov. 1, 2018

(54) REAR SUSPENSION FOR SPEAKER DRIVERS

(71) Applicant: Kimon Bellas, Camarillo, CA (US)

(72) Inventors: Kimon Bellas, Camarillo, CA (US); Alan Dwight Hulsebus, II, Simi Valley, CA (US)

(73) Assignee: Kimon Bellas, Camarillo, CA (US)

(21) Appl. No.: 15/498,239

(22) Filed: Apr. 26, 2017

(51) Int. Cl. H04R 7/16; H04R 7/12; H04R 9/06; H04R 1/10; H04R 9/02

(52) U.S. Cl. CPC H04R 7/16; H04R 7/127; H04R 9/025; H04R 1/1008; H04R 1/1058; H04R 9/06

(57) ABSTRACT

Devices and methods described herein relate to novel and improved speaker drivers that can optimize the movement, efficiency, and/or performance of components. Additionally, speaker drivers according to the present disclosure can reduce the overall device failure rate and increase the overall lifetime of the device. Embodiments can improve component efficiency through novel rear suspensions which can reduce unwanted component movement and distortion. Rear suspensions herein can also allow other components, such as magnetic gaps, to be efficiently designed. Furthermore, rear suspensions can improve the audio output and quality of the device. Moreover, rear suspensions herein can allow air to more easily flow through the speaker driver, which can improve the air cooling throughout the device. In addition, rear suspensions herein can reduce the overall air pressure of the speaker driver.

### BACKGROUND

### Field

The present disclosure relates generally to audio transducers and/or speaker drivers, and more particularly to speaker drivers with novel and improved structural features and suspension designs.

### Description of the Related Art

Speaker drivers are a type of audio transducer that convert electrical audio signals to sound waves. Speaker drivers are commonly associated with specialized transducers, which can reproduce a portion of the audible frequency range. Speaker drivers are sometimes referred to as loudspeakers. A common type of speaker driver, often referred to as a dynamic or electrodynamic driver, converts electric current to sound waves via a coil of wire. This is widely known as a voice coil, which is often suspended between magnetic poles. During operation, a signal is delivered to the voice coil by means of electrical wires. The current flowing in the voice coil creates a magnetic field that causes a component, such as a diaphragm, to be forced in one direction or another. This force can move against a field established by magnetic gaps as the electrical signal varies.

The back-and-forth, oscillatory motion drives the air in the device, which results in pressure differentials that convert to sound waves. Put more succinctly, speaker drivers utilize electrical audio signals to drive air through controlled movement, which in turn results in sound output. To generate a wide range of sound, different speaker drivers can be utilized to each cover a portion of the desired frequency range.

Speaker drivers can use a diaphragm or cone that supports a voice coil, which can also be on a magnet. In some speaker drivers, the voice coil resides in a position within the magnetic gap. The voice coil can also be connected to a dome, such that movement of the dome is controlled by changes to the electrical signals. The movement of the voice coil must follow a precise cylindrical path so that it does not contact the base cup around the magnetic gap. Any contact with the base cup can cause rubbing or a buzzing noise, which can result in high distortion. This contact can also result in destruction of the speaker driver, wherein the voice coil wire insulation is destroyed causing a short circuit. Accordingly, precise alignment and movement of the voice coil is essential.

One type of undesired voice coil movement is rocking, which is when left and right movement causes the voice coil to contact the base cup around the magnetic gap. Essentially, rocking is when the forward and back movement of the voice coil deviates from the ideal cylindrical path. Rocking is a significant problem that causes distortion, shortens the device lifetime, and limits audio output. Most small speakers, including micro speakers, headphones, and dome tweeters, use only one suspension element to position and center the voice coil in the magnetic gap, which results in a rocking problem. Large speakers like midrange, woofers and subwoofers use two or more axial spaced suspension elements to combat rocking.

Small speakers with single suspension often use Ferrofluid in the magnetic gap to reduce rocking and damp resonance. Ferrofluid is often called “liquid suspension” and has several unwanted side effects. Ferrofluid is popular because it has a strong centering force and improves heat conduction for improved power handling. However, with large excursion Ferrofluid develops a loud “whoosh” noise from flow currents and a sizzle noise from trapped air bubbles that can be louder than the music or voice. With large excursion, the Ferrofluid can be expelled from the magnetic gap and splatter on the surrounding speaker parts until there is insufficient Ferrofluid to provide a centering suspension force. The viscus damping of Ferrofluid also introduces undesirable damping (lower Qₘ) that reduces bass extension/efficiency. The undesired damping also reduces micro-dynamics that is especially noticeable as reduced spacial ambience, wherein soft sounds are compressed and lost. Indeed, many ultimate fidelity dome tweeters and headphones choose to eliminate Ferrofluid because the unwanted side effects outweigh the benefits.

Several different factors can cause rocking. For example, if the mass moment of the moving assembly is not perfectly balanced, it may tip to one side when excitation force is applied by the voice coil. This can be caused by glue not being distributed in an equal volume or shape around the entire cylinder. Additionally, this can be because the tensile wires are not attached to the bobbin at 180 degrees separation to balance mass.

Another factor that can cause rocking is the spring force of the suspension not being completely linear around the 360 degree circle and cylindrical path. This can be caused by unequal thickness or stiffness in the suspension material. Also, if the glue is not distributed equally then the suspension width may not be consistent, which means the suspension spring force and maximum spring deflection are not symmetric. Increasing the front and back travel is necessary to increase volume output, which also increases the difference in spring force imbalance, so the maximum volume is also limited by rocking. Another factor is the tensile wires exiting in the same direction, whereas the best practice is to exit the bobbin at precisely 180 degrees in tangent opposition, which causes the spring force to be balanced.

Another factor that can cause rocking is the magnetic gap not being an equal width around the entire cylinder. When the magnetic gap is narrow there is more flux strength versus when the magnetic gap is wide. This can result in the voice coil excitation force not being balanced around the entire cylinder, which results in more movement in locations where the force is higher.

In an attempt to solve the problems mentioned above, those in the art have used a number of different structures. However, the aforementioned issues continue to exist, which continue to present problems for speaker drivers.

### SUMMARY

The present disclosure relates to novel and improved speaker drivers that optimize the movement and efficiency of components. Speaker drivers according to the present disclosure have an improved ability to reduce the failure rate and increase the overall lifetime of the device. The present disclosure also provides speaker drivers that can optimize the component performance and audio output. Additionally, speaker drivers described herein can provide a novel and improved manner in which to foster air cooling and reduce the overall air pressure in the device.

Embodiments according to the present disclosure can improve the component efficiency of the speaker driver through a novel rear suspension design. Rear suspension designs according to the present disclosure can reduce the amount of unwanted component movement, which can in turn reduce the amount of component-caused distortion. As a result, rear suspensions according to the present disclosure can reduce the component failure rate and increase the overall lifetime of the speaker driver. Some rear suspension embodiments according to the present disclosure can package two axial spaced suspension elements in the limited space of small speakers without increasing depth. Embodiments herein can also be applied to large speakers to greatly reduce depth. Rear suspensions according to the present disclosure can also allow other components to be designed in a more efficient manner, such as efficiently designed magnetic gaps. Moreover, rear suspensions can allow other components to improve the overall audio output and quality of the device.

Embodiments according to the present disclosure can also include rear suspensions that can improve air cooling and reduce the air pressure. Rear suspension designs according to the present disclosure can allow air to more easily move throughout the speaker driver, which can improve the overall air cooling ability of the device. Further, rear suspension designs according to the present disclosure can reduce the overall air pressure in the device. However, it is understood that any component in the speaker driver can utilize the novel and improved features described in the embodiments herein.

One embodiment according to the present disclosure includes a speaker driver comprising a rear suspension which comprises a suspension center and a suspension edge. A dome comprising a dome center structure can be on the rear suspension, wherein the suspension center contacts the dome center structure. The rear suspension can at least partially confine the movement of the dome. The speaker driver can further comprise a front suspension on the dome, wherein the rear suspension and the front suspension at least partially confine the movement of the dome.

Another embodiment according to the present disclosure includes a speaker driver comprising a rear suspension that comprises a suspension center and a suspension edge. A dome comprising a dome center structure can be on the rear suspension. Moreover, a front suspension can be on the dome. Additionally, a base cup can be on the rear suspension, wherein the base cup can comprise at least one base cup gap.

In yet another embodiment, the present disclosure can include a headphone assembly comprising a speaker driver, which can comprise a rear suspension comprising a suspension center and a suspension edge. A dome comprising a dome center structure can be on the rear suspension. Furthermore, the suspension center can contact the dome center structure. In addition, a front suspension can be on the dome.

These and other further features and advantages of the disclosure would be apparent to those skilled in the art from the following detailed description, taken together with the accompanying drawings, in which:

### BRIEF DESCRIPTION OF THE DRAWINGS

FIG. 1A is a top side perspective view of one embodiment of a speaker driver according to the present disclosure;

FIG. 1B is a bottom side perspective view of the speaker driver in FIG. 1A;

FIG. 1C is a top view of the speaker driver in FIG. 1A;

FIG. 1D is a bottom view of the speaker driver in FIG. 1A;

FIG. 1E is a side view of the speaker driver in FIG. 1A;

FIG. 2A is an exploded perspective view of the speaker driver in FIG. 1A;

FIG. 2B is sectional cut-out view of the speaker driver in FIG. 1A;

FIG. 3A is a top side perspective view of one embodiment of a rear suspension according to the present disclosure;

FIG. 3B is a side cutaway view of the rear suspension in FIG. 3A;

FIG. 3C is a top view of the rear suspension in FIG. 3A;

FIG. 4 is a side view of one embodiment of an inverted dome according to the present disclosure;

FIG. 5 is a top side perspective view of one embodiment of a voice coil according to the present disclosure;

FIG. 6 is a top side perspective view of one embodiment of a front suspension according to the present disclosure;

FIG. 7 is a top side perspective view of one embodiment of a bobbin according to the present disclosure;

FIG. 8A is a top side perspective view of one embodiment of a motor assembly according to the present disclosure;

FIG. 8B is a top view of the motor assembly in FIG. 8A;

FIG. 9 is a top side perspective view of one embodiment of a base cup according to the present disclosure;

FIG. 10A is a top side perspective view of one embodiment of a magnet according to the present disclosure;

FIG. 10B is a top side perspective view of one segment of the magnet shown in FIG. 10A;

FIG. 11 is a top side perspective view of one embodiment of a Faraday ring according to the present disclosure;

FIG. 12 is a top side perspective view of one embodiment of a suspension ring according to the present disclosure;

FIG. 13A is a top side perspective view of one embodiment of a grille according to the present disclosure;

FIG. 13B is a side view of the grille in FIG. 13A;

FIG. 14 is a top side perspective view of one embodiment of a basket according to the present disclosure;

FIG. 15A is a top side perspective view of one embodiment of a negative terminal board according to the present disclosure;

FIG. 15B is a top side perspective view of one embodiment of a positive terminal board according to the present disclosure;

FIG. 16A is a sectional cut-out view of another embodiment of a speaker driver according to the present disclosure;

FIG. 16B is a top side perspective view of a rear suspension in the embodiment of FIG. 16A;

FIG. 16C is a top side perspective view of a front suspension in the embodiment of FIG. 16A;

FIG. 16D is a top side perspective view of an inverted dome in the embodiment of FIG. 16A;

FIG. 16E is a top side perspective view of a voice coil in the embodiment of FIG. 16A;

FIG. 16F is a top side perspective view of a bobbin in the embodiment of FIG. 16A;

FIG. 17A is a sectional cut-out view of another embodiment of a speaker driver according to the present disclosure;

FIG. 17B is a top side perspective view of a rear suspension in the embodiment of FIG. 17A;

FIG. 17C is a top side perspective view of a front suspension in the embodiment of FIG. 17A;

FIG. 18A is a sectional cut-out view of another embodiment of a speaker driver according to the present disclosure;

FIG. 18B is a top side perspective view of a rear suspension in the embodiment of FIG. 18A;

FIG. 18C is a top side perspective view of a front suspension in the embodiment of FIG. 18A;

FIG. 19A is a sectional cut-out view of another embodiment of a speaker driver according to the present disclosure;

FIG. 19B is a top side perspective view of a rear suspension in the embodiment of FIG. 19A;

FIG. 19C is a top side perspective view of a front suspension in the embodiment of FIG. 19A;

FIG. 19D is a top side perspective view of an inverted dome in the embodiment of FIG. 19A;

FIG. 19E is a top side perspective view of a voice coil in the embodiment of FIG. 19A; and

FIG. 19F is a top side perspective view of a bobbin in the embodiment of FIG. 19A.

### DETAILED DESCRIPTION

The present disclosure relates to novel and improved speaker drivers that can optimize the movement, efficiency, and/or performance of components. Additionally, speaker drivers described herein can reduce the overall device failure rate and increase the overall lifetime of the device. Embodiments herein can improve component efficiency through novel rear suspensions which can reduce unwanted component movement and distortion. Rear suspensions herein can also allow other components, such as magnetic gaps, to be more efficiently designed. Furthermore, rear suspensions herein can improve the audio output and quality of the device. Moreover, rear suspensions herein can allow air to more easily flow through the speaker driver, which can improve the air cooling throughout the device. In addition, rear suspensions herein can reduce the overall air pressure of the speaker driver.

Speaker drivers according to the present disclosure are described herein as being utilized with headphones and/or speakers. However, it is understood that speaker drivers according to the present disclosure can be used in a wide variety of audio devices, including but not limited to headphones, microphones, hearing aids, in-ear monitors, micro speakers, tweeters, midrange speakers, woofers, and/or subwoofers. Moreover, speaker drivers according to the present disclosure can be used in any appropriate device or transducer application, such as motors, actuators, sensors, or any similar application.

Throughout this disclosure, the preferred embodiment and examples illustrated should be considered as exemplars, rather than as limitations on the present disclosure. As used herein, the term “invention,” “device,” “apparatus,” “method,” “disclosure,” “present invention,” “present device,” “present apparatus,” “present method” or “present disclosure” refers to any one of the embodiments of the disclosure described herein, and any equivalents. Furthermore, reference to various feature(s) of the “invention,” “device,” “apparatus,” “method,” “disclosure,” “present invention,” “present device,” “present apparatus,” “present method” or “present disclosure” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. In contrast, when an element is referred to as being “directly on” or extending “directly onto” another element, there are no intervening elements present. Additionally, it is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Furthermore, relative terms such as “inner,” “outer,” “upper,” “top,” “above,” “lower,” “bottom,” “beneath,” “below,” and similar terms, may be used herein to describe a relationship of one element to another. Terms such as “higher,” “lower,” “wider,” “narrower,” and similar terms, may be used herein to describe angular relationships. It is understood that these terms are intended to encompass different orientations of the elements or system in addition to the orientation depicted in the figures.

Although the terms first, second, third, etc., may be used herein to describe various elements, components, regions, and/or sections, these elements, components, regions, and/or sections should not be limited by these terms. These terms are only used to distinguish one element, component, region, or section from another. Thus, unless expressly stated otherwise, a first element, component, region, or section discussed below could be termed a second element, component, region, or section without departing from the teachings of the present disclosure. As used herein, the term “and/or” includes any and all combinations of one or more of the associated list items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. For example, when the present specification refers to “an” assembly, it is understood that this language encompasses a single assembly or a plurality or array of assemblies. It is further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

Embodiments of the disclosure can be described herein with reference to view illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region and are not intended to limit the scope of the disclosure.

It is understood that while the present disclosure makes reference to speaker drivers with novel and efficient designs, and that speaker drivers may be the primary application concerned with the present disclosure, devices incorporating features of the present disclosure can be utilized with any application that has components or elements which might be concerned with audio devices and/or transducer applications, such as speakers, motors, actuators, sensors, or any similar application that may benefit from a novel and efficient component design.

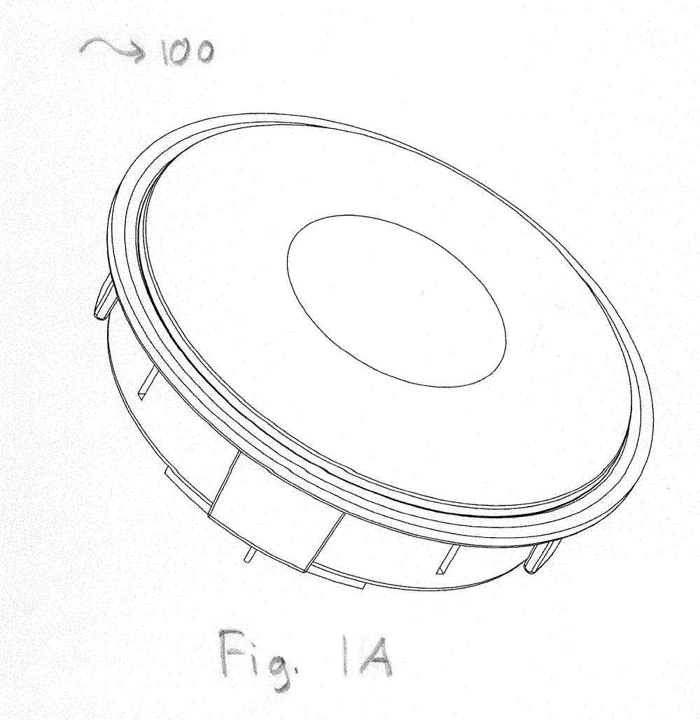

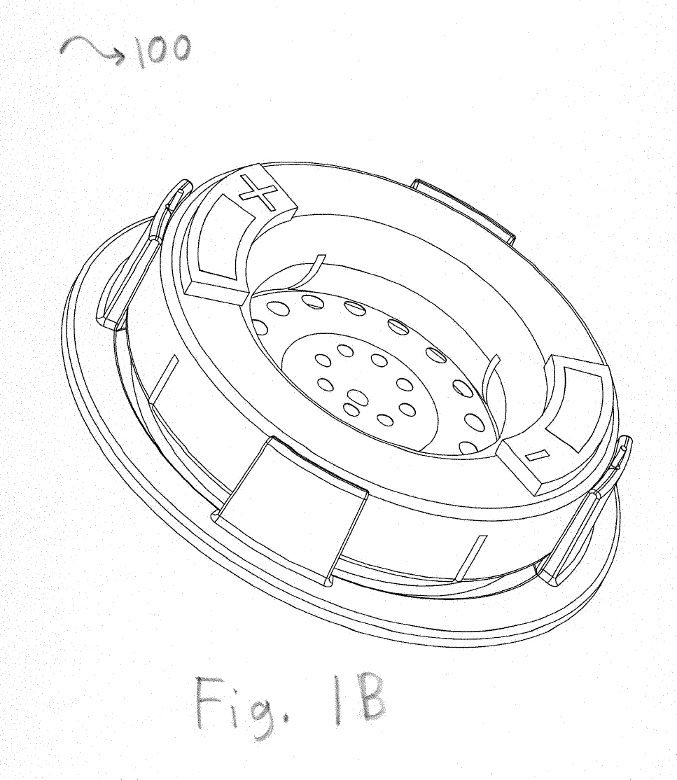

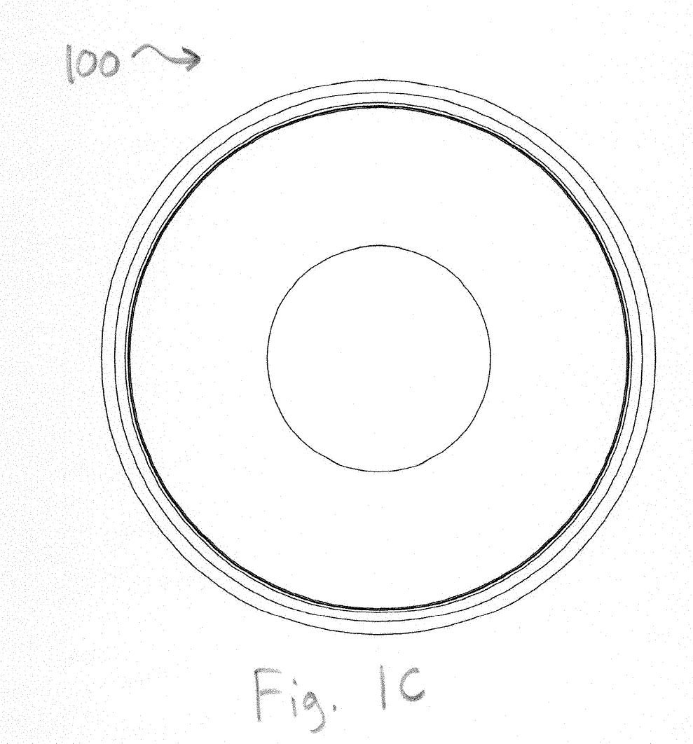

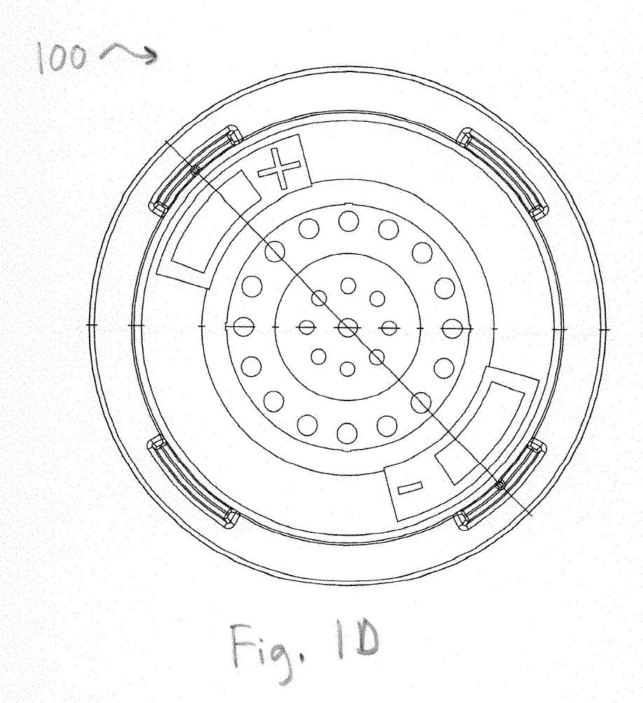

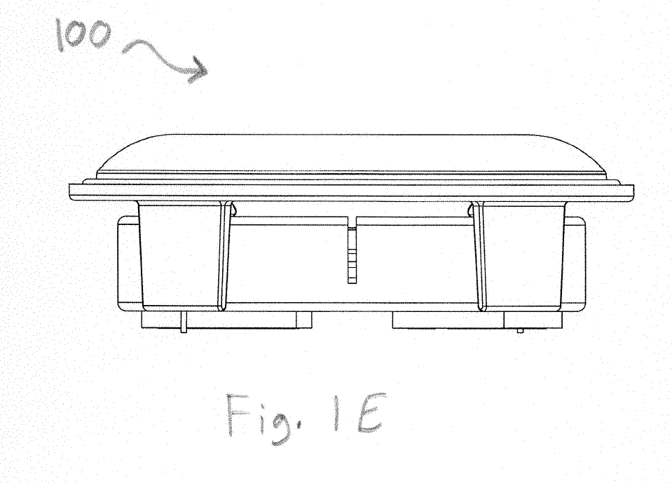

Embodiments according to the present disclosure can comprise speaker drivers with novel and improved component efficiency. FIG. 1A displays one embodiment of speaker driver 100, which comprises many of the novel and improved features described herein. Speaker driver 100 can have features that optimize the efficiency and performance of components, such as by maximizing and/or improving the movement of components. Further, speaker driver 100 can include features which increase the lifetime and reduce the failure rate of the device. Speaker driver 100 can also improve component efficiency with the novel suspensions described herein.

Speaker driver 100 can also include components, such as rear suspensions, that can also allow other components to be more efficiently designed, as well as reduce component-caused distortion. Moreover, rear suspensions of speaker driver 100 can improve the device audio output and quality. Speaker driver 100 can also include components that improve air cooling and reduce the air pressure. Additionally, rear suspensions according to speaker driver 100 can allow air to more easily flow throughout the device, which can in turn improve the air cooling and reduce the air pressure in the device. It is understood that speaker driver 100 can be referred to as a speaker driver, driver, and/or audio transducer, as well as any other appropriate term.

In order to show speaker driver 100 in its entirety, FIGS. 1B-1E provide several differently angled views of speaker driver 100.

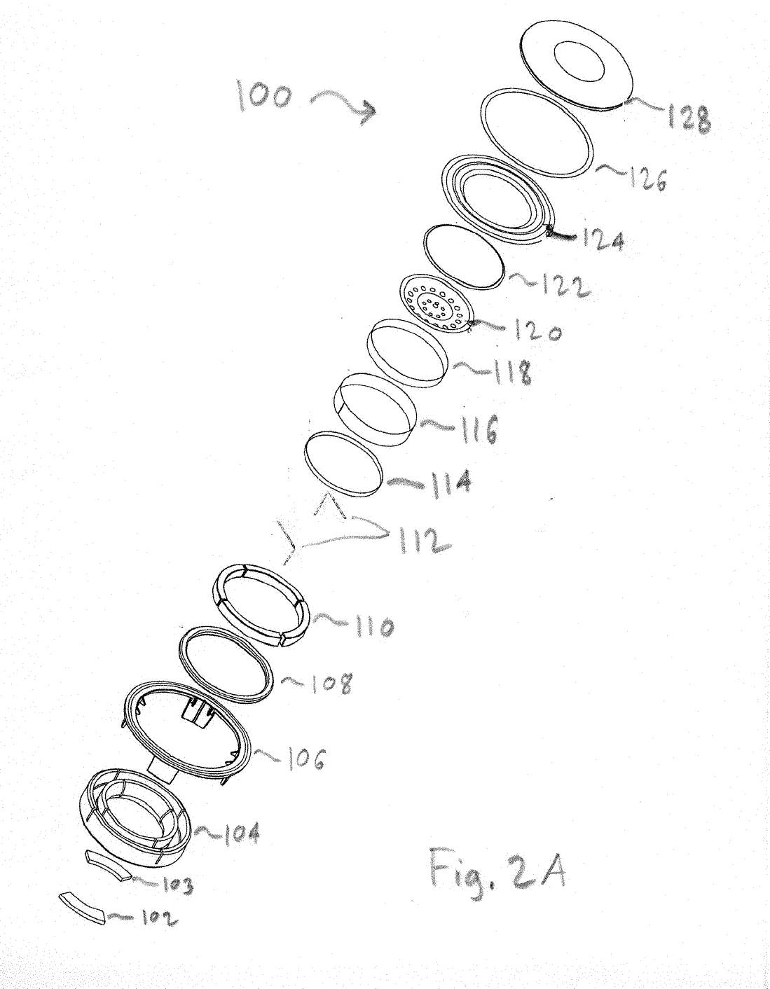

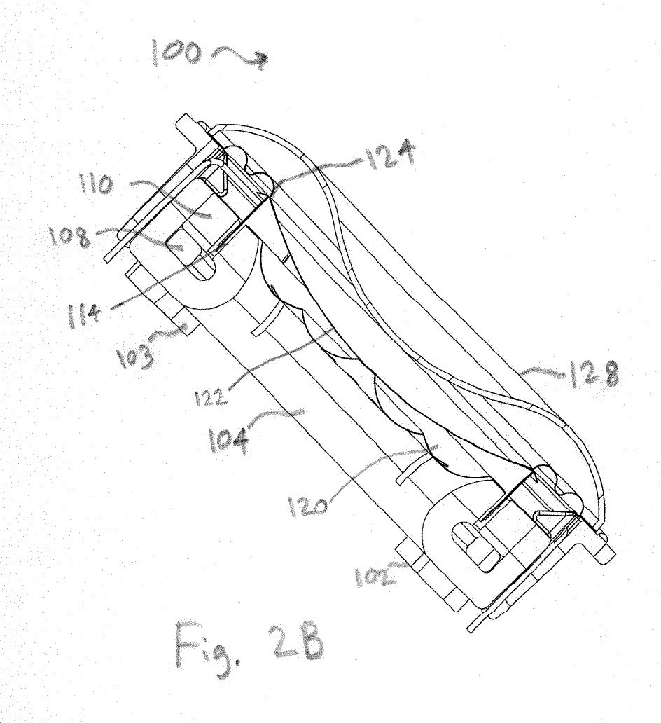

The speaker drivers according to the present disclosure comprise many different components. FIG. 2A displays that speaker driver 100 comprises rear suspension 120, inverted dome 122, voice coil 114, front suspension 124, and bobbin 116. Speaker driver 100 also comprises tensile wire 112, collar 118, suspension ring 126, and grille 128. Additionally, speaker driver 100 comprises base cup 104, Faraday ring 108, and magnet 110, which make up the motor assembly portion of the driver. Yet other speaker driver components that are adjacent to the motor assembly are basket 106 and terminal board 102/103.

The relative position of each component is important to the ability of the speaker driver to function property. Accordingly, FIG. 2B provides a view of the respective component positions of speaker driver 100.

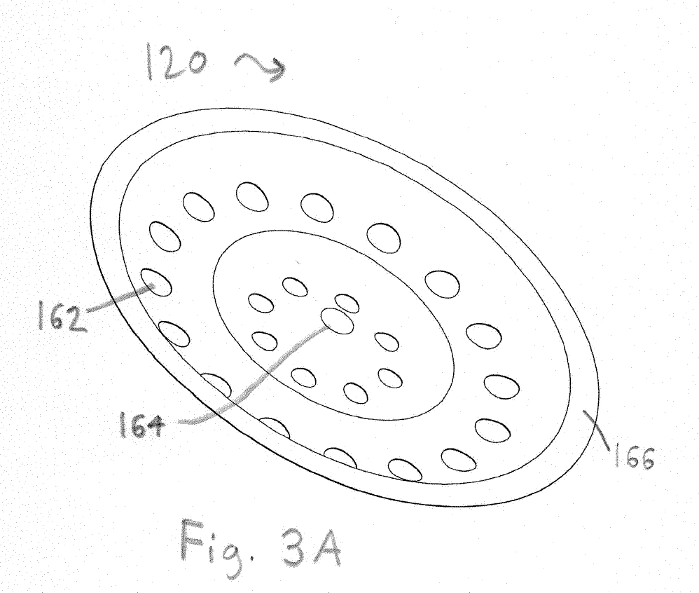

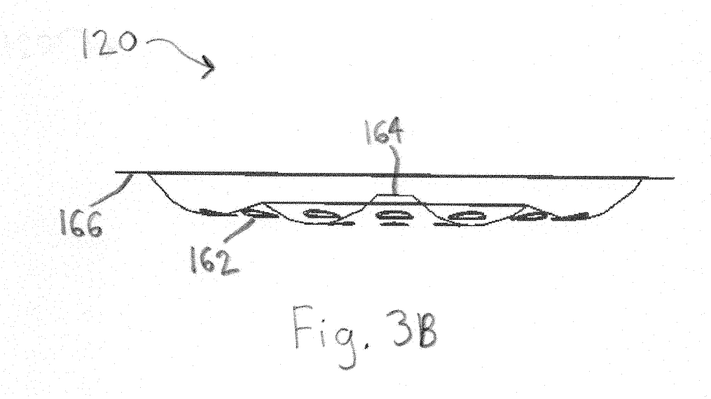

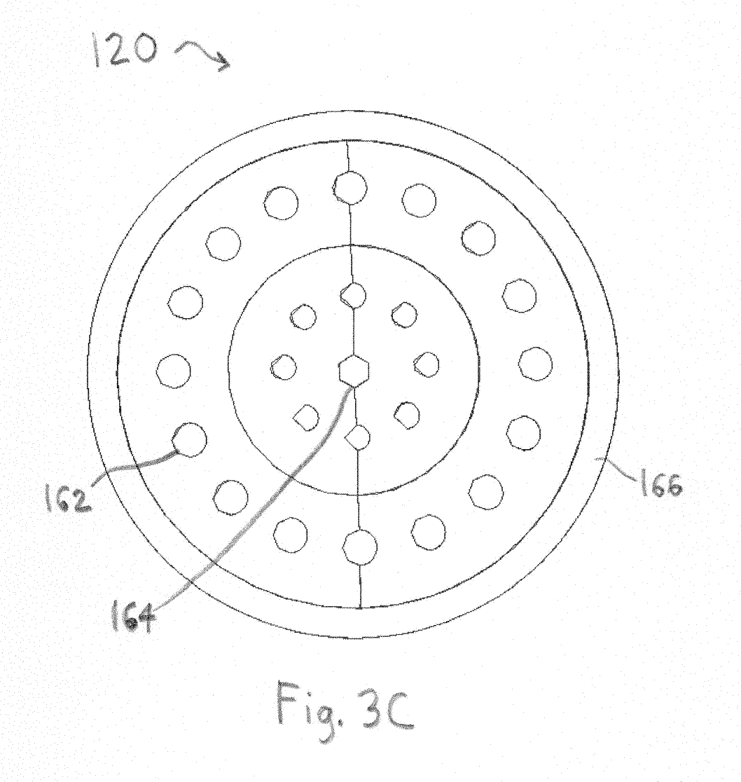

Some of the novel and improved features of the present disclosure relate to improving the overall efficiency of the speaker driver. FIGS. 3A-3C each display differently angled views of rear suspension 120. As shown in FIGS. 3A-3C, rear suspension 120 comprises vent holes 162, suspension center 164, and suspension edge 166. As described herein, rear suspension 120 can optimize the efficiency and/or performance of speaker driver 100. Rear suspension 120 can also help to maximize the efficiency of component movement in the speaker driver 100. In addition, rear suspension 120 can increase air cooling throughout the speaker driver 100 and reduce air pressure buildup. Rear suspension 120 can also reduce the overall failure rate of speaker driver 100, as well as increase the overall lifetime of the device.

Rear suspensions according to the present disclosure can reduce or minimize unwanted component movement. For example, rear suspension 120 can prevent component “rocking,” which is the unwanted deviation of component movement from its intended path. In some instances, rocking can refer to the unwanted movement of the voice coil or dome. However, it is understood that rocking can refer to any number of speaker driver components. Regarding the voice coil, rocking can refer to the left or right movement of the voice coil, which deviates from the ideal forward or back movement along the cylindrical path. In some instances of voice coil rocking, the voice coil 114 makes unintended contact with the base cup 104. Rear suspension 120 can prevent this voice coil rocking, as well as center the voice coil 114 in the proper position relative to other speaker driver components.

Rear suspension 120 can reduce or minimize voice coil and/or dome rocking in a variety of manners. In some embodiments, rear suspension 120 can contact the center of inverted dome 122. As best shown in the cut-out view of FIG. 2B, suspension center 164 can contact the tip of dome center structure 142. Indeed, suspension center 164 can contact, support, and/or stabilize the center of inverted dome 122. Because suspension edge 166 can also contact the base cup 104, rear suspension 120 can connect, and essentially anchor itself between, the inverted dome 122 and the base cup 104. Accordingly, base cup 104 can allow rear suspension 120 to prevent any unwanted movement or rocking of the inverted dome 122. Because voice coil 114 can be attached to inverted dome 122, rear suspension 120 can also reduce or minimize unwanted movement or rocking of voice coil 114.

Attaching suspension center 164 to dome center structure 142 is a practical manner in which to reduce or minimize rocking, as the configuration of inverted dome 122 and base cup 104 allows rear suspension 120 to easily connect between these components. For instance, the depression or central air vent in the base cup 104 allows room to place rear suspension 120 below the inverted dome 122. Indeed, rear suspension 120 fits naturally below inverted dome 122 and inside the center of base cup 104. This efficient configuration can also reduce the overall mass of speaker driver 100. However, it is understood that rear suspension 120 can reduce or minimize rocking through a number of different configurations, as well as contacting a number of different components within speaker driver 100. Additionally, in order to minimize unwanted movement or rocking, embodiments according to the present disclosure can comprise a rear suspension spring force that is linear around the entire cylindrical path.

As mentioned above, the outer diameter of rear suspension 120 can span from the center of the speaker driver to the base cup 104. For instance, suspension edge 166 can contact, and rest upon, the inner diameter of the base cup 104. However, rear suspension 120 can connect to any part and at any depth of the motor assembly, including but not limited to base cup 104. In order to attach the outside diameter of the rear suspension 120, adhesives may be applied to the front, rear, or inside diameter surfaces of the base cup 104. As such, the plane height of rear suspension 120 may be chosen to ease the manufacturing process. In some embodiments, the outer diameter of suspension edge 166 does not extend into the gap between the inner diameter of the base cup 104 and the magnet 110. In yet other embodiments, the outer diameter of suspension edge 166 can extend into the gap between the inner diameter of the base cup 104 and the magnet 110. It is understood that rear suspensions according to the present disclosure can comprise a variety of different configurations and/or dimensions.

In some embodiments according to the present disclosure, the depth of dome center structure 142 can be strategically placed in alignment with the top of the magnet gap, which allows for easy “in plane” attachment of the outside diameter of rear suspension 120. Moreover, the depth of dome center structure 142 can be aligned with the back of the voice coil 114, so that the moving mass is between the planes of rear suspension 120 and front suspension 124. This configuration allows for improved component stability within speaker driver 100. Additionally, the depth of inverted dome 122 can be chosen based on the desired frequency characteristics, so the suspension plane separation may not be as ideal for stability purposes. However, the addition of rear suspension 120 still vastly improves component stability compared to speaker drivers with single suspension designs.

One reason that rear suspension 120 adds component stability, and reduces or minimizes rocking, concerns stabilizing the planes between speaker driver components. For instance, it is difficult to stabilize all three (x,y,z) planes with a single suspension. However, because speaker driver 100 includes both front suspension 124 and rear suspension 120, there are essentially two anchor points with which to isolate component movement. Indeed, rear suspension 120 allows the z plane to be stabilized, such that the x,y planes are locked out or isolated. As mentioned above, attaching suspension center 164 to dome center structure 142 can stabilize the z plane of the dome 122 to reduce or minimize rocking.

As mentioned previously, dome and/or voice coil rocking has a number of unwanted side effects, such as distortion and component failure. For instance, rocking can cause the voice coil to rub against other components. Because the rear suspension 120 prevents rocking, it can cause a reduction in distortion or noise within the speaker driver 100, as well as prolong the lifetime of components such as voice coil 114. Additionally, because the rear suspension 120 prevents rocking, the gap between the inner diameter of base cup 104 and magnet 110 can be narrower, which in turn can improve the efficiency of the speaker driver. Rear suspension 120 can also allow the motor assembly to be designed with a longer linear excursion, which can increase bass output and/or reduce distortion. This can be a big advantage in a variety of speaker drivers, such as those used in headphones, micro speakers, and/or midrange speakers.

The aforementioned component configuration or topology can also be used to reduce the size of drivers used in certain speakers, such as reducing the depth of woofers and/or subwoofers. For example, placing the rear suspension 120 inside the base cup 104 allows the speaker driver depth to be reduced. In some instances, the speaker driver depth can be reduced by the same amount as the maximum one way suspension excursion, which, for example, in a subwoofer can be around 0.5 to 2 inches. Other speaker driver components can also assist with the overall depth reduction. For instance, the large diameter of voice coil 114 can reduce bending stress on speaker driver components, such as the dome or cone, so that these components can use a shallower angle. In turn, this can reduce the speaker driver depth, which, for example, in a subwoofer can be around 0.5 to 3 inches.

Vent holes 162 can also provide many advantages to the speaker driver. For example, vent holes 162 can allow more air to circulate throughout the speaker driver. As improved air flow can provide cooling effects, vent holes 162 can also help to reduce component temperature throughout the device. Because the speaker driver includes many metal components that are sensitive to increases in temperature, this improved air flow can help to maintain component performance. For instance, the voice coil is sensitive to temperature increases, so the increased air flow can maintain voice coil efficiency. However, it is understood that the increased air flow can improve the performance and efficiency of any component in the speaker driver.

In addition, vent holes 162 can reduce the amount of air that is trapped within the speaker driver. In turn, this reduces the amount of air pressure buildup in the device. This is significant because trapped air has several unwanted side effects, such as resonance or noise. As such, vent holes 162 can improve the overall efficiency and sound quality of the speaker driver. Moreover, vent holes 162 can allow other aspects of the speaker driver to be improved. For instance, as a result of vent holes 162 and the corresponding improved air flow, the air gap between the magnet and the base cup can be reduced, which can in turn allow the magnetic strength in the device to be maximized.

There are several reasons as to why air is trapped in the speaker driver and needs to be released. For instance, air is displaced when the dome or cone moves forward and back along the cylindrical path, so that air restriction needs to be reduced. Further, the air volume between the front and rear suspensions is not constant, therefore air can be trapped in this region. Speaker driver 100 can reduce air restriction and/or release trapped air with vent holes 162. It is understood that vent holes can be provided in a number of different speaker driver components besides the rear suspension, such as the voice coil, bobbin, and front suspension. Additionally, air vent gaps can be provided and between the rear suspension and the attachment point at the base cup. Placing vents or holes in a variety of speaker driver components can minimize the chance of acoustic cavity resonance and/or Helmholtz resonance, and increase the summed flow area.

Adding air vent holes in the rear suspension 120 can also lower the spring stiffness for a lower resonance frequency, as well as allow for a large summed flow area. Strategic placement of the vent holes 162 in the rear suspension can also lower undesired spurious structural resonance. Moreover, placing vent holes 162 throughout the rear suspension radius eases the punch manufacturing process, as well as allows CNC lasers used in manufacturing to cut more complex hole shapes and suspension geometries. Equal vent hole sizes also makes it convenient for conventional punch manufacturing, while CNC laser-cut holes can have fewer restrictions.

In some embodiments, rear suspension 120 can comprise a porous material, which can have similar advantages to the aforementioned vent holes. Accordingly, such speaker driver embodiments including rear suspensions with porous materials may not comprise vent holes 162. However, it is understood that rear suspensions according to the present disclosure can comprise a number of different materials and configurations, including, but not limited to, those comprising the aforementioned air flow and cooling advantages.

Embodiments according to the present disclosure include rear suspensions that can comprise a variety of materials. For example, rear suspension 120 can comprise a polyester fabric that is PVA coated, as well as comprise a tweeter dome fabric thickness and coating. In one embodiment, the rear suspension has a diameter of 31 mm and a thickness of 2.77 mm. However, it is understood that suspension components according to the present disclosure can comprise any number of appropriate dimensions or materials.

The rear suspension geometry and/or materials can be chosen based on the preferred or intended application, for example, spring stiffness, required linear excursion, required moving mass, and/or air ventilation. The type of speaker used in these applications, e.g. micro speakers, headphones, tweeters, and/or woofers, can use geometries and materials that are conventionally used in these corresponding applications. For speaker drivers used in headphone applications, the suspension designs can be softer and have a longer excursion than those used in dome tweeters. However, it is understood that speaker driver geometries and materials can be similar or different depending on the type of application.

Rear suspensions according to the present disclosure can also have a variety of designs and configurations. As shown in FIGS. 3A-3C, some rear suspensions of the present disclosure can comprise a wave or “M-shaped” design. There are several reasons to use this type of design, such as having a low distortion when certain materials are used, such as an elastomer coated fabric. M-shaped rear suspension designs, such as those described herein, can use two or three waves or rolls, depending on required excursion and material self-resonance properties of the speaker driver. However, it is understood that any appropriate number of waves or rolls can be used. Other suspension geometries can also be used, such as half rolls, accordion spiders, and/or flat foams. It is understood that any number of different rear suspension geometries can be used.

Rear suspension materials are chosen for a variety of reasons. For example, elastomer coated fabric can be used because the x,y plane stiffness is stronger than other materials, e.g. rubber or foam, it has a lighter mass for a given stiffness in x,y,z planes, it is resistant to gravity sag or “creep,” and/or it has an improved environmental life. Other rear suspension materials can also be used, such as rubber, foam, plastic, and conventional spider. It is understood that any number of different rear suspension materials can be used.

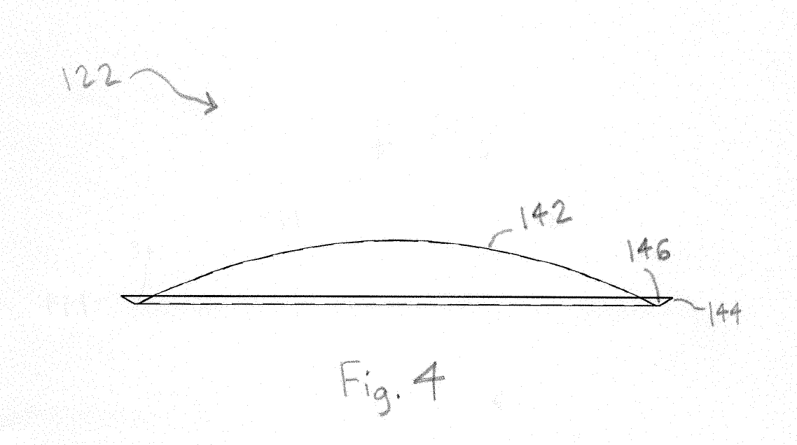

Embodiments of the present disclosure can also include novel and improved dome structures. FIG. 4 displays inverted dome 122. Inverted dome 122 comprises dome center structure 142, dome edge 144, and trough 146. As shown in FIG. 4, dome edge 144 is bent back at an angle adjacent to trough 146. More specifically, trough 146 is formed by dome edge 144 being bent back at the intersection with dome center structure 142. FIG. 4 displays one embodiment of the configuration of dome edge 144 being bent. However, it is understood that many different types of dome edges can be used. A variety of different dome structures can also be used. In some embodiments, dome center structure 142 can comprise a catenary shape.

Domes according to the present disclosure can comprise a number of different materials. For instance, dome 122 can comprise beryllium, AlBeMet, aluminum, and/or aluminum alloy. Dome 122 can also comprise magnesium, titanium, diamond, carbon fiber, paper, hard plastics, plastic films, metals, metal foils, metal alloys, ceramics and/or other materials with strong structural fibers. In some embodiments according to the present disclosure, dome 122 can comprise rubber, silk, polyester fabric, Kevlar, and/or Mylar. It is understood that domes of the present disclosure can comprise any number of appropriate materials.

Dome 122 can also comprise a variety of different dimensions. In one embodiment, dome 122 has a diameter of 34 mm and is 0.05 mm thick. In some embodiments, dome edge 144 has a bend back between 0.5 mm and 1 mm. However, the bend back length can depend on the type of material of dome 122. A thicker membrane material, e.g. paper, plastic foam, or sandwich construction can require a wider bend back. It is understood that dome 122 can comprise any number of appropriate dimensions.

As mentioned above, rear suspension 120 can reduce or minimize the unwanted movement or rocking of dome 122, which can refer to movement that deviates from the ideal forward or back movement along the cylindrical path. Rear suspension 120 can reduce or minimize rocking of dome 122 in a variety of ways. In some embodiments, rear suspension 120 can contact the center of inverted dome 122. Indeed, suspension center 164 can contact, support, and/or stabilize the center of dome 122, such as at dome center structure 142. Suspension edge 166 can also contact the base cup 104, so rear suspension 120 can anchor itself between the inverted dome 122 and the base cup 104. As such, base cup 104 can also allow rear suspension 120 to prevent any unwanted movement or rocking of inverted dome 122.

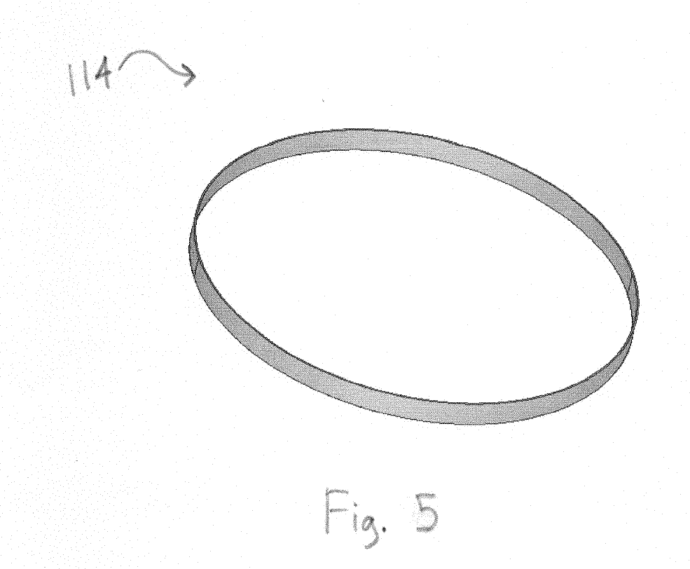

Embodiments of the present disclosure can also comprise novel and improved voice coils. FIG. 5 displays voice coil 114. Voice coils according to the present disclosure can be a wide variety of lengths, such as under hung, over hung, or equal hung, as well as any other appropriate length. In one embodiment, the voice coil can comprise a 32 mm diameter and a 1.75 mm thickness. The voice coil 114 can also comprise two layers, a CCAW of 0.06 mm×42.5 turns, a 1.75 mm wind width, and/or a DCR of 27 ohm.

Rear suspension 120 can reduce or minimize the unwanted movement or rocking of voice coil 114. Regarding the voice coil, rocking can refer to the left or right movement of the voice coil, which deviates from the ideal forward or back movement along the cylindrical path. As mentioned previously, in some instances of voice coil rocking, the voice coil can make unintended contact with the base cup. Rear suspension 120 can prevent this voice coil rocking, such as by reducing or limited voice coil 114 from contacting base cup 104. Additionally, rear suspension 120 can center the voice coil 114 in the proper position relative to other speaker driver components.

Rear suspension 120 can reduce or minimize voice coil rocking in a variety of manners. In some embodiments, rear suspension 120 can contact the center of inverted dome 122, which in turn prevents voice coil rocking. Indeed, because voice coil 114 can be attached to inverted dome 122, rear suspension 120 can also reduce or minimize unwanted movement or rocking of voice coil 114. As mentioned above, voice coil rocking has a number of unwanted side effects, such as distortion and component failure, which can be caused by the voice coil rubbing against other components. Because the rear suspension 120 can prevent voice coil rocking, it can cause a reduction in distortion or noise within the speaker driver 100, as well as prolong the lifetime of voice coil 114.

Embodiments according to the present disclosure can also comprise other voice coil geometries and configurations. For instance, some embodiments can move the rear suspension 120 closure to the voice coil 114. By doing so, this can greatly improve the resonance stability of the speaker driver, as well as prevent the any unwanted sideways movement of the voice coil. Some embodiments can also comprise voice coils with large diameters. This provides several advantages, such as reducing bending stress on the cone, so that a shallow angle cone can be used to substantially reduce cone depth. For example, in a subwoofer, this can save 0.5 to 3 inches of depth.

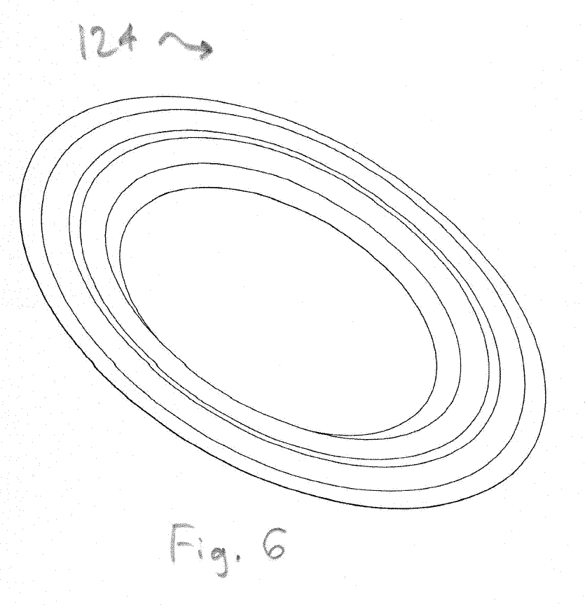

Embodiments of the present disclosure can also comprise several different components used for improving component efficiency. FIG. 6 displays one embodiment of a front suspension 124 according to the present disclosure. In embodiments according to the present disclosure, front suspension 124 can be connected to the dome 122, such as with an adhesive or glue. In some embodiments, the front suspension 124 can be connected to the surface of dome 122, wherein it contributes to the dome's structural stability. In other embodiments, front suspension and dome can be molded from the same component, such that they comprise a single piece structure.

FIG. 6 shows that front suspension 124 can comprise a polyester fabric that is PVA coated. Front suspension 124 can also comprise a suspension width of 5.5 mm. Additionally, the front suspension can comprise a tweeter dome fabric thickness or coating. It is understood that front suspension 124 can comprise any number of appropriate materials. The front suspension design can also be relatively soft over the necessary +/−Xmax excursion, such that it does not cause the dome to flex. Additionally, the front suspension 124 can be adhered or glued to the curved surface of dome 122, so that it does not cause the dome 122 to unnecessarily flex.

Embodiments according to the present disclosure can utilize both the front suspension 124 and the rear suspension 120 in conjunction to optimize component efficiency. For instance, some embodiments can include front suspension 124 and rear suspension 120 that are at different heights. By doing so, front suspension 124 and rear suspension 120 can more easily prevent dome rocking, such as like a cone woofer. Moreover, front suspension 124 and rear suspension 120 can be separated by distance in the z plane, which in turn reduces unwanted movement in the x,y planes. As described above, by isolating the x,y planes, this improves component stability and in turn reduces unwanted component movement or rocking.

In order to achieve improved component stability, the moving mass should be between the planes of front suspension 124 and rear suspension 120. As mentioned above, the depth of dome center structure 142 can be aligned with the back of the voice coil 114, so that the moving mass is between the planes of rear suspension 120 and front suspension 124. This configuration can allow for improved component stability within speaker driver 100. Furthermore, the plane of front suspension 124 can be widely separated from the plane of rear suspension 120.

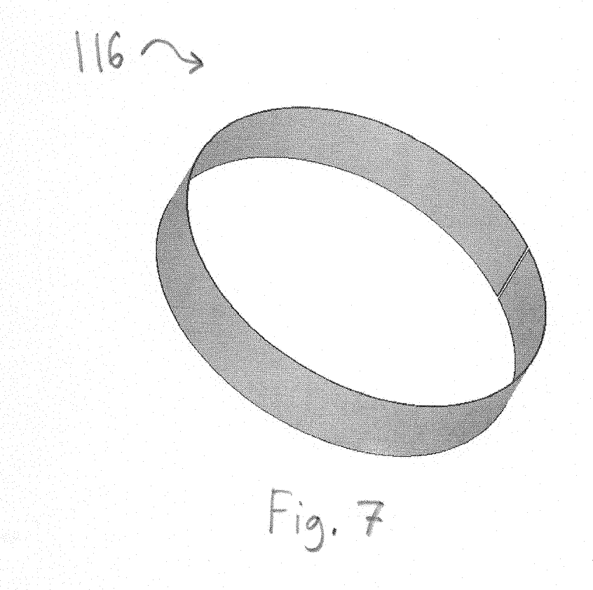

Embodiments of the present disclosure can also comprise novel and improved bobbins. FIG. 7 shows bobbin 116. Bobbin 116 can comprise Kapton or other similar materials. However, it is understood that bobbins according to the present disclosure can comprise any number of appropriate materials or dimensions.

Embodiments according to the present disclosure can also comprise other components that can be used in conjunction with voice coils and bobbins. For instance, collar 118 and tensile wire 112 (both shown in FIG. 2A) can comprise Nomex and Taiwan Maiden anti-roping, respectively. In some embodiments, tensile wire 112 can be 0.5 mm×35 mm long. It is understood that other components according to the present disclosure, such as collars and tensile wires, can comprise any appropriate material or dimension.

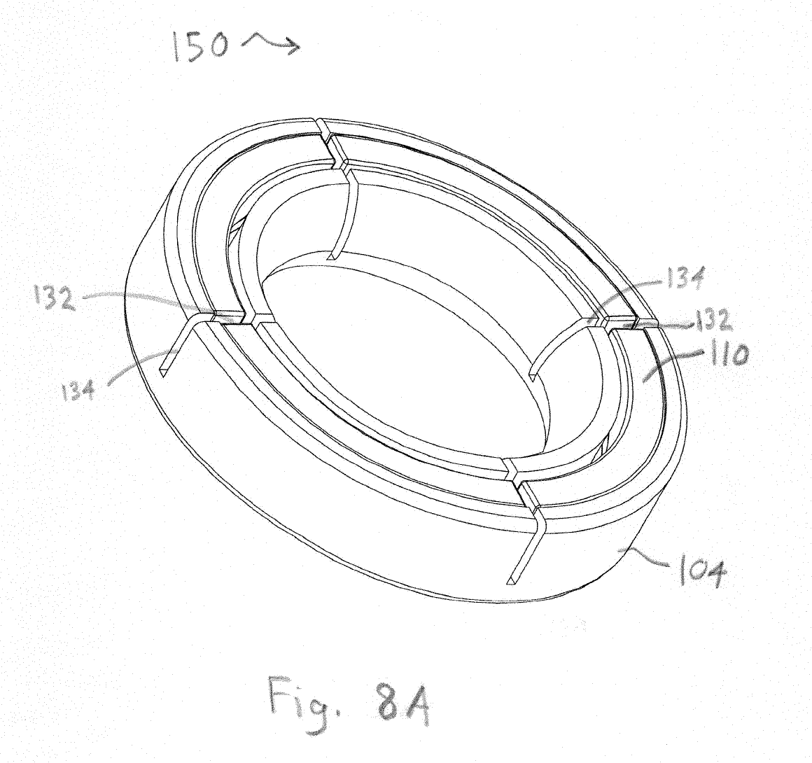

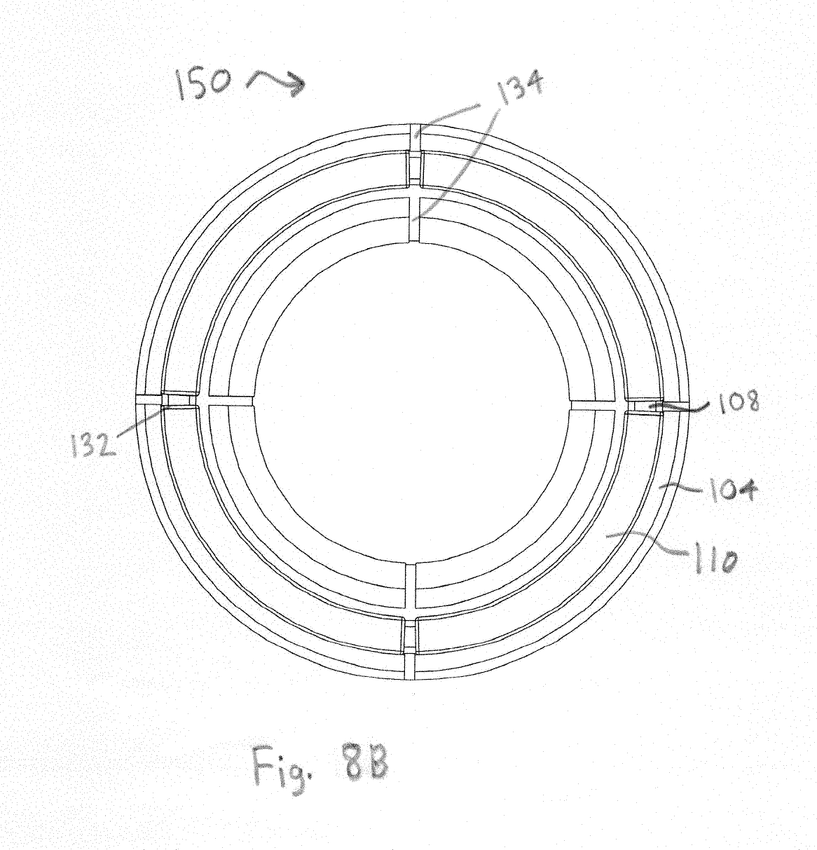

Embodiments of the present disclosure can also comprise speaker driver components that can help with alignment. FIGS. 8A and 8B display motor assembly 150. Motor assembly 150 comprises base cup 104, base cup slots 134, Faraday ring 108, magnet 110, and magnet gaps 132. As displayed in FIGS. 8A and 8B, base cup 104 and base cup slots 134 can be aligned with magnet 110 and magnet gaps 132. Although FIGS. 8A and 8B display four magnet gaps 132 and four base cup slots 134, it is understood that any number of magnet gaps or base cup slots can be used, such as six, eight, or any other appropriate number.

Speaker driver designs herein can be scaled to any size speaker, such as hearing aids, in-ear monitors, other headphones, all types of microphones including dynamic microphones, micro speakers, tweeters, midrange speakers, woofers, and/or subwoofers. Motor assembly 150 can also comprise additional topologies, such as a multi-gap topology or any other appropriate topology. In one embodiment, the motor assembly can be 52 mm in diameter and weigh 51.5 grams. However, it is understood that motor assemblies according to the present disclosure can be any appropriate dimension or weight.

As shown in FIG. 8B, Faraday ring 108 can sit in the base cup 104 below magnet 110. In this manner, Faraday ring 108 can control the height of magnet 110 within the base cup 104. More specifically, Faraday ring 108 can control the height alignment of magnet gaps 132 with base cup slots 134. Accordingly, Faraday ring 108 plays an important role in the magnetic alignment within the speaker driver.

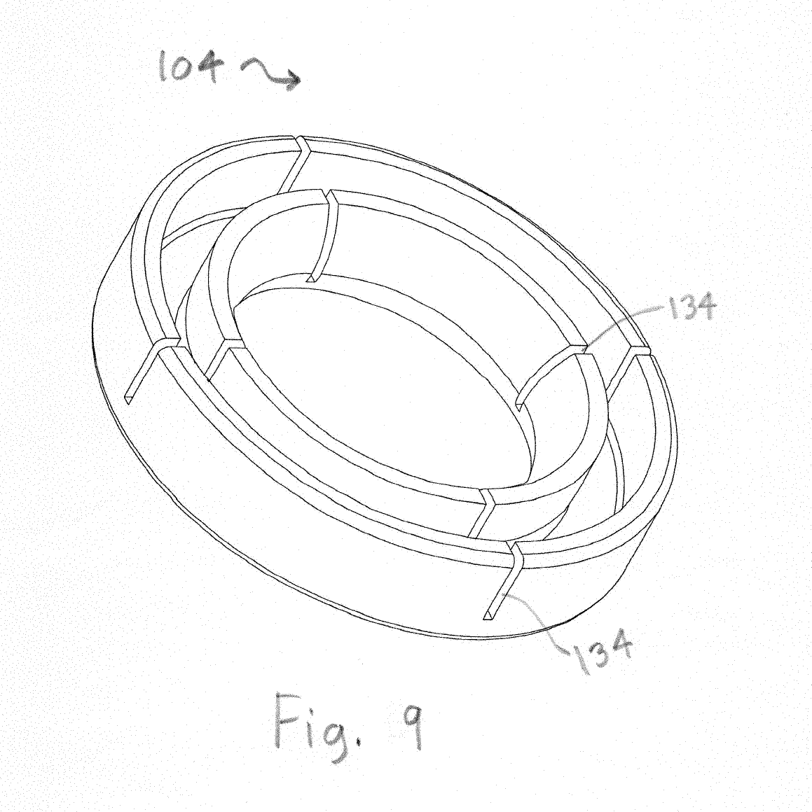

The individual components that make up motor assembly 150 are displayed in FIGS. 9-11. FIG. 9 displays base cup 104. As mentioned previously, base cup 104 can comprise base cup slots 134 in both the inside and outside portions of the base cup. Base cup 104 can comprise a variety of different steel materials, including steel 1010 or steel 1008. Base cup can also comprise plating, such as Rohs compliant plating. This type of plating can be 5 microns thick, and comprise zinc and gold trivalent chromate. Additionally, base cup 104 can weigh approximately 40 grams. The length of base cup can be approximately 36 mm, with a tolerance of ±0.025 mm. Further, the flatness rate of base cup can be ±0.1 mm per 25 mm, and the surface finish can be 0.002 mm. However, it is understood that base cups according to the present disclosure can comprise any number of appropriate dimensions or materials.

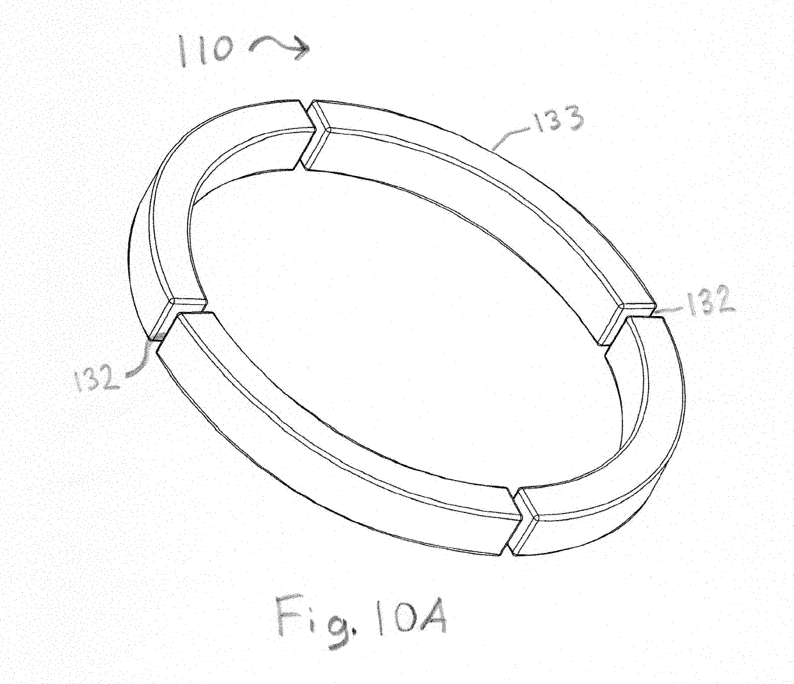

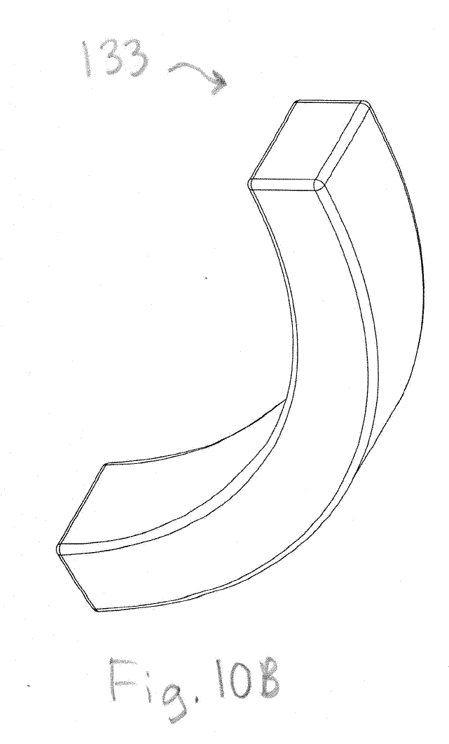

Embodiments according to the present disclosure can comprise several types of magnets. FIG. 10A displays magnet 110, which comprises one or more magnet gaps 132. In embodiments according to the present disclosure, magnet gaps 132 can run entirely through magnet 110. As shown in FIG. 10A, magnet 110 can actually comprise one or more segments 133. Although four individual segments are shown in FIG. 10A, it is understood that any appropriate number of magnet gaps and individual magnet segments can be used, such as four, five, six, seven, or eight segments.

As displayed in FIGS. 10A and 10B, magnet 110 can be a type of magnet suitable for speaker drivers, such as a radial magnet. Furthermore, magnet 110 can be in an arc shape, such that it can be referred to as an arc magnet. Magnet 110 can also be a combination of the aforementioned magnet types, wherein it can be a radial arc magnet. More specifically, magnet 110 can be a radial magnetized neodymium arc shape magnet. It is understood that magnets according to the present disclosure can be any other appropriate type of magnet. In some embodiments, magnet 110 comprises a ceramic material. However, any appropriate type of magnet material can be used, such as Ferrite, Neodymium, Samarium Cobalt, AlNiCo, electro magnet, or any other appropriate material. Magnets can also comprise a zinc plate and weigh approximately 2.4 grams. It is understood that magnets can weigh any appropriate amount and include any appropriate dimension.

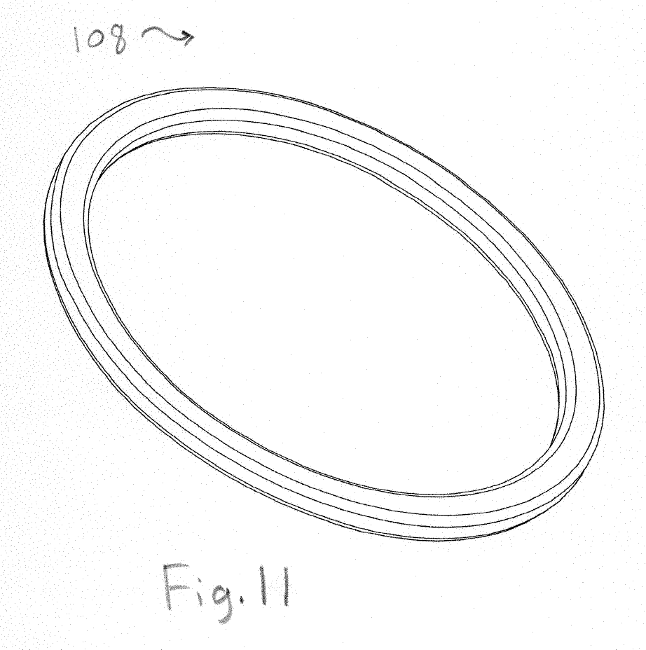

Other aspects of the speaker driver can reduce the buildup of inductance. FIG. 11 displays Faraday ring 108. Faraday ring 108 can have many benefits, such as reducing the buildup of, or linearizing, inductance, as well as increasing high frequencies and reducing intermodulation distortion. Essentially, Faraday ring 108 can cause current to correctly flow through the device. It is understood that Faraday ring 108 can also be referred to as a short-circuit ring or a shorting ring, as well as any other appropriate term.

As mentioned previously, Faraday ring 108 can reduce opposing “eddy” currents that would normally flow through the device. Faraday ring 108 accomplishes this by essentially short circuiting the eddy currents. Without the Faraday ring 108, the inductance in the device can increase significantly, which can likewise increase the temperature in the device. Faraday ring 108 can comprise a number of different materials with electrically conductive properties and/or low electrical resistance. For example, Faraday ring 108 can comprise aluminum, alloy aluminum, silver, copper, alloy copper, such as brass, bronze, other copper alloys or electrical grade alloys, as well as other appropriate non-ferrous or electrically conductive materials. In one embodiment, Faraday ring 108 can weigh a few grams, e.g. approximately 1.5 grams. However, it is understood that Faraday rings according to the present disclosure can weigh any other appropriate amount.

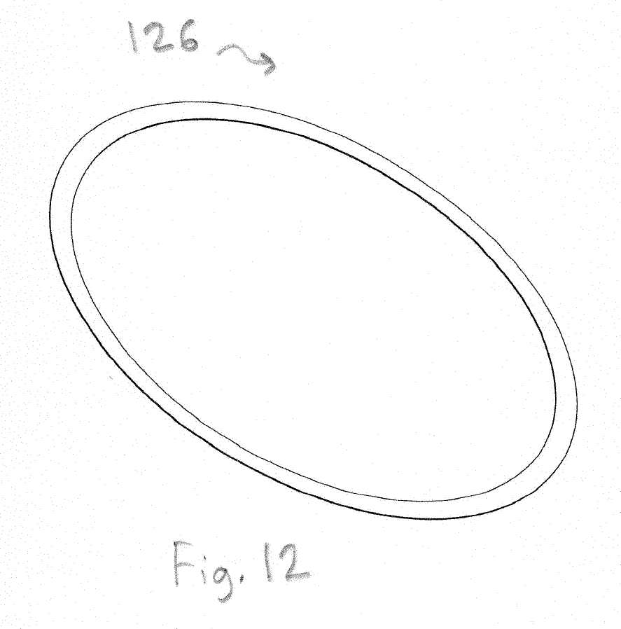

Embodiments of the present disclosure can also comprise several different components used for suspension, such as a suspension ring. FIG. 12 displays suspension ring 126 that can comprise a plastic material, such as a clear Polyethylene naphthalate (PEN) plastic. Suspension ring 126 can also comprise any other material that can provide good reinforcement and flatness characteristics.

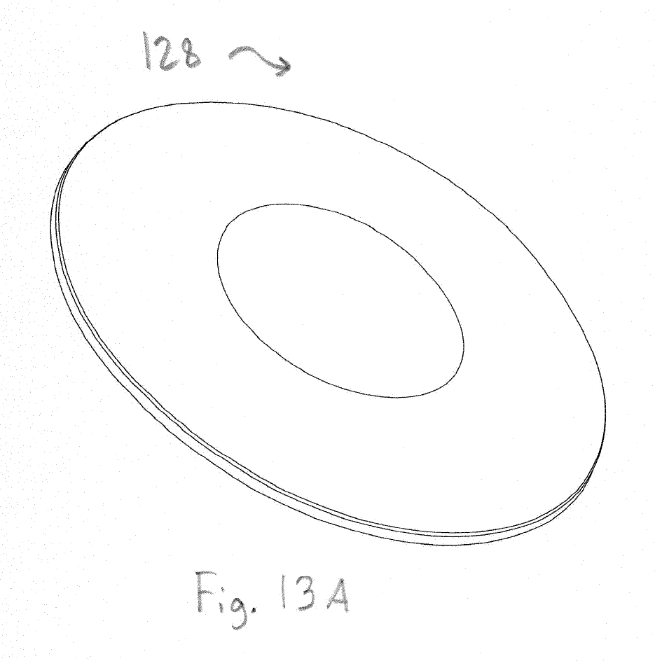

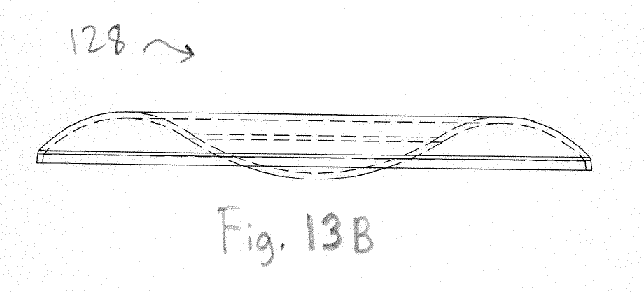

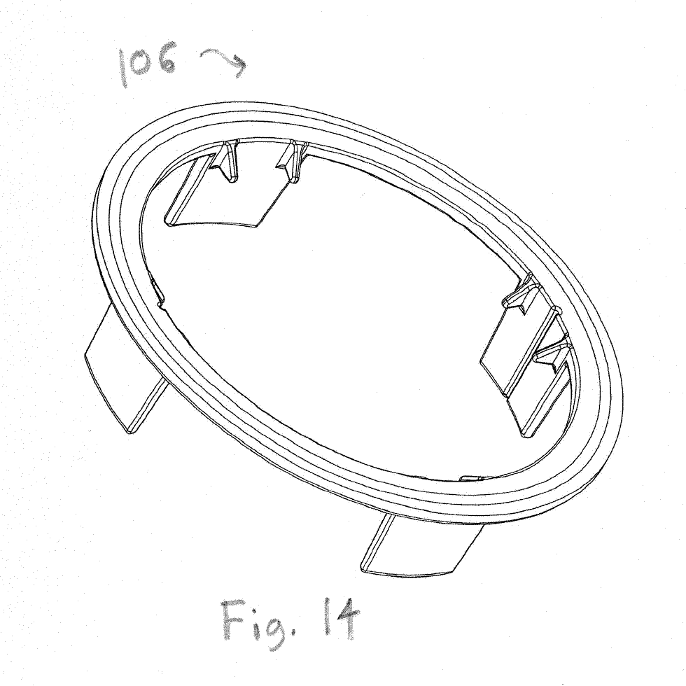

Speaker driver embodiments according to the present disclosure can comprise components such as baskets or grilles. FIGS. 13A and 13B displays grille 128, which can comprise a steel material, such as 316 stainless. The grille can also be hexagonally perforated with a 79% open area, including a 0.5 mm thickness. The grille can also comprise a black electroless nickel plate including 7% phosphorus. In one embodiment, grille can have a diameter of 47 mm and a mass of 1.7 grams. FIG. 14 displays basket 106, which can comprise a plastic material, such as black ABS plastic. In one embodiment, basket 106 can have a mass of 1.67 grams and a diameter of 52 mm. It is understood that baskets or grilles according to the present disclosure can comprise any number of appropriate dimensions or materials.

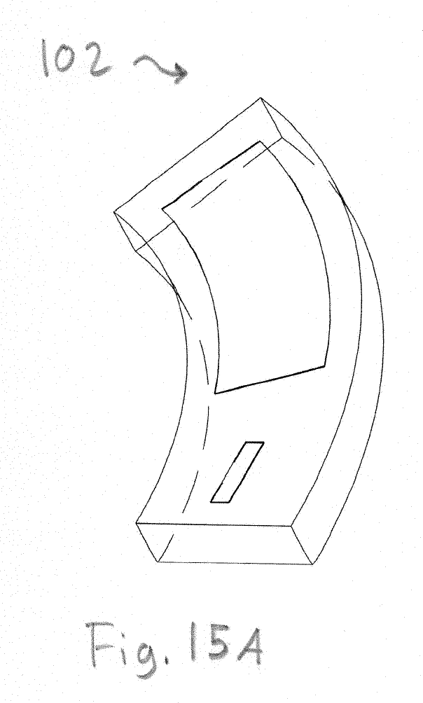

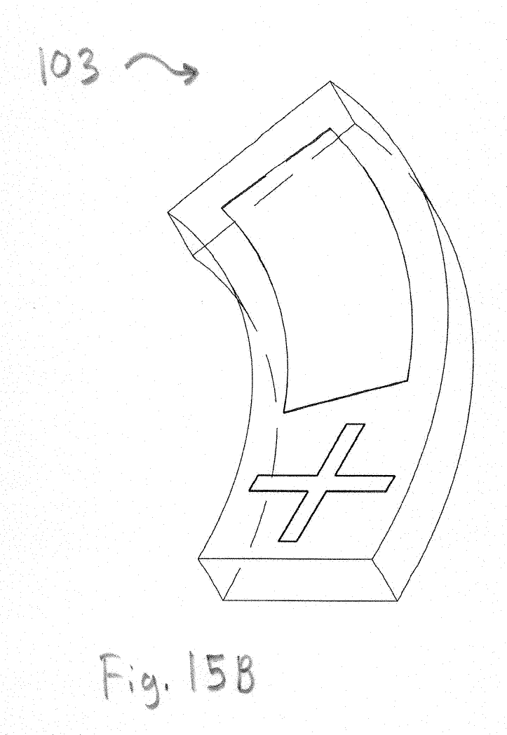

Embodiments according to the present disclosure can also comprise terminal boards, as displayed in FIGS. 15A and 15B. Specifically, FIG. 15A displays negative terminal board 102, while FIG. 15B shows positive terminal board 103. It is understood that some embodiments of the present disclosure may not use a terminal board, but rather an equivalent component, such as a terminal strip or a printed circuit board, as well as any other appropriate component. In one embodiment, the terminal board comprises copper and/or tin material, and is a black color. For example, the terminal board can comprise a tin plate and one ounce of copper. However, it is understood that terminal boards according to the present disclosure can comprise any number of appropriate materials.

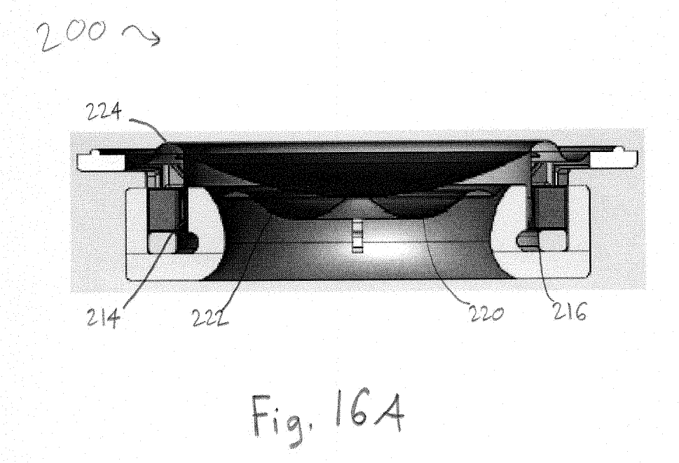

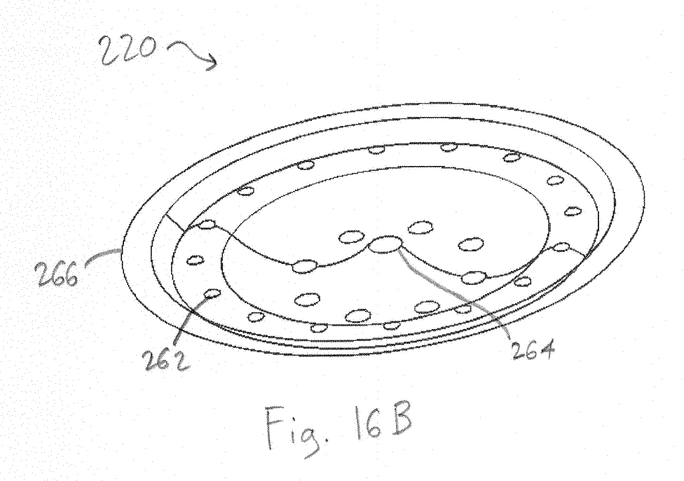

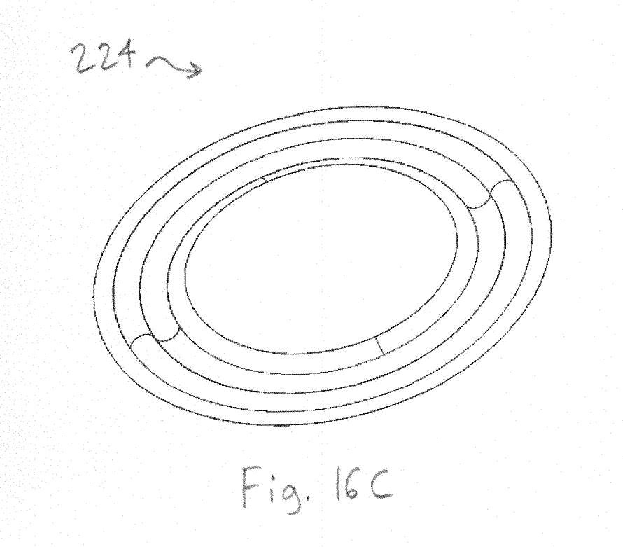

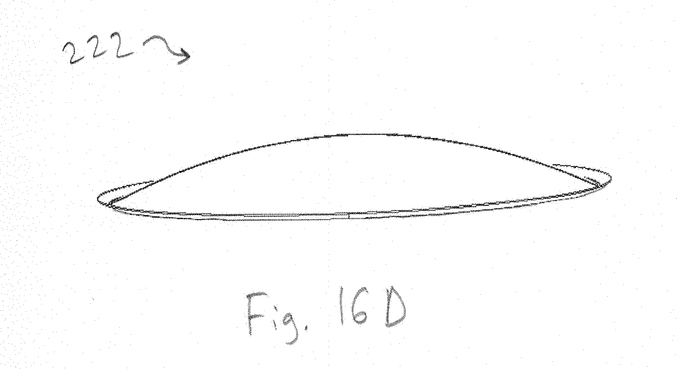

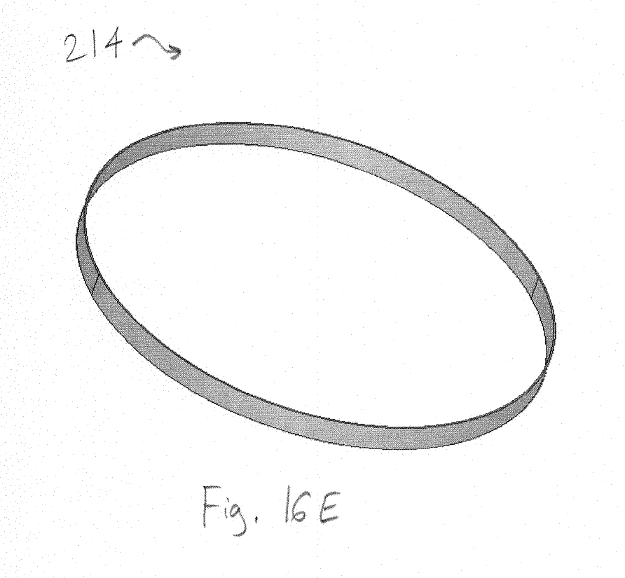

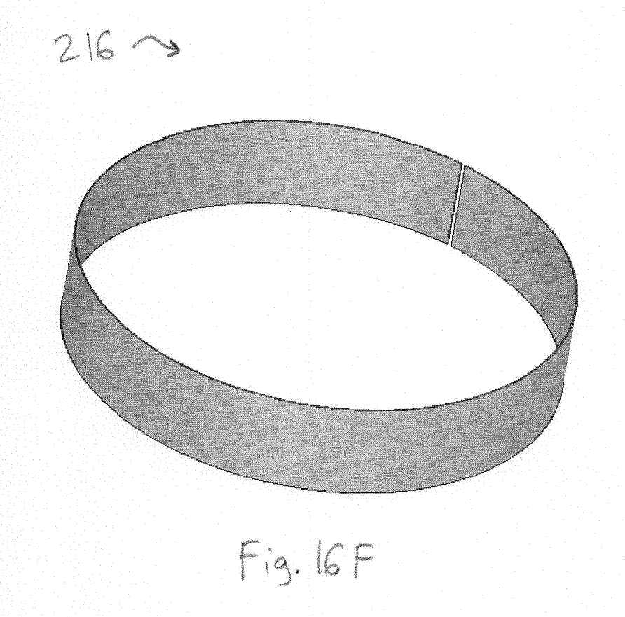

The present disclosure also provides embodiments with different speaker driver designs. For instance, suspensions according to the present disclosure can have a wide variety of designs. FIGS. 16A-19F display several different embodiments of speaker drivers and/or suspensions. FIG. 16A displays one such type of speaker driver 200, which comprises rear suspension 220, front suspension 224, inverted dome 222, voice coil 214, and bobbin 216. Each of these components are displayed in FIGS. 16B-16F, respectively.

Suspensions can have components with varied structural designs. For example, rear suspension 220 includes a structure with a varied design. As shown in FIG. 16B, rear suspension 220 comprises vent holes 262, suspension center 264, and suspension edge 266. The varied design of rear suspension 220 causes vent holes 262 to be at different levels. This design can be referred to as an “S” design. FIG. 16C displays that front suspension 224 can also comprise an alternate design. Front suspension 224 can include a type of wave structure, which can also be referred to as an “S” design.

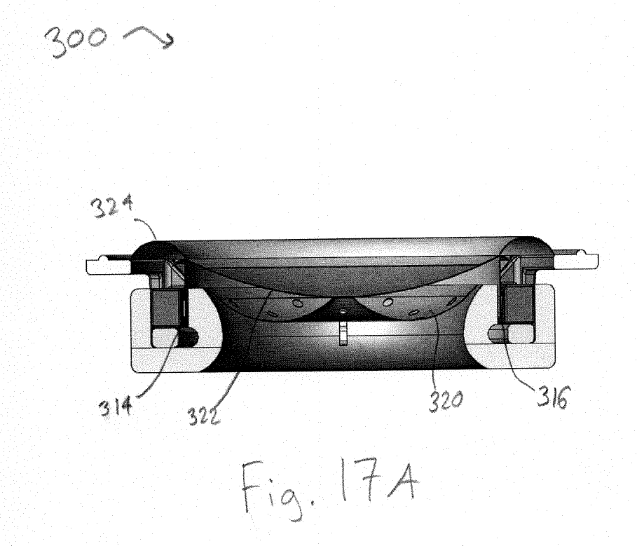

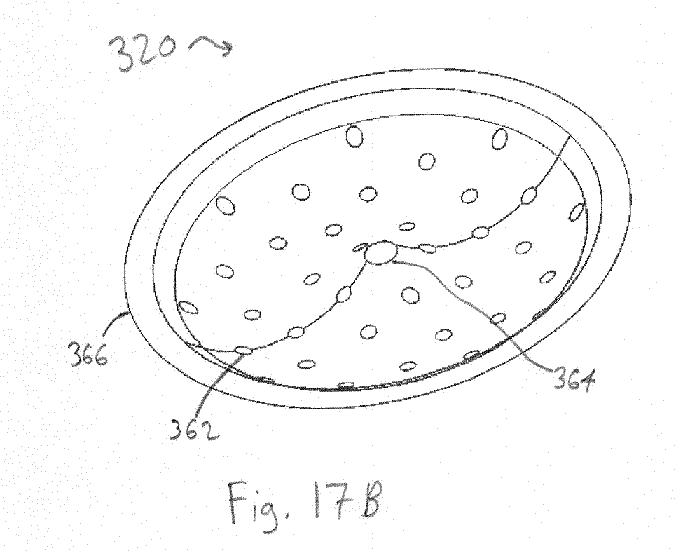

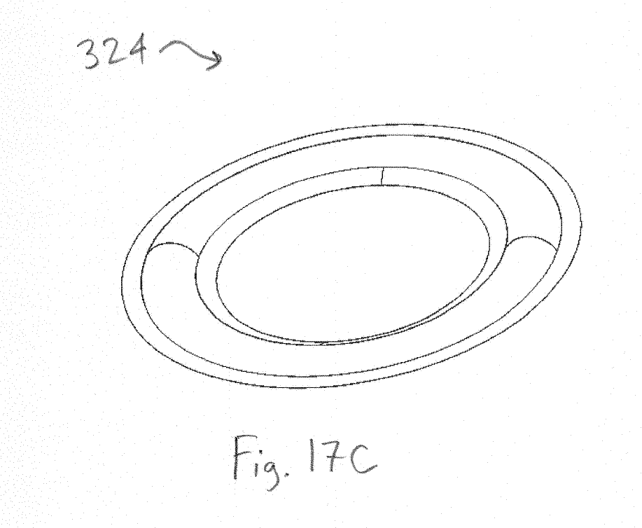

Components in speaker drivers according to the present disclosure can comprise further variance in designs. FIG. 17A displays another such design of speaker driver 300 according to the present disclosure. Speaker driver 300 comprises rear suspension 320, front suspension 324, inverted dome 322, voice coil 314, and bobbin 316.

Rear suspension 320 includes another type of structure with a varied design. As shown in FIG. 17B, rear suspension 320 comprises vent holes 362, suspension center 364, and suspension edge 366. The vent holes 362 in rear suspension 320 can all be part of the same wave or curve. This structure can be referred to as a half roll design. FIG. 17C displays that front suspension 324 can also comprise an alternate design, which can include a larger single wave structure and also be referred to as a half roll.

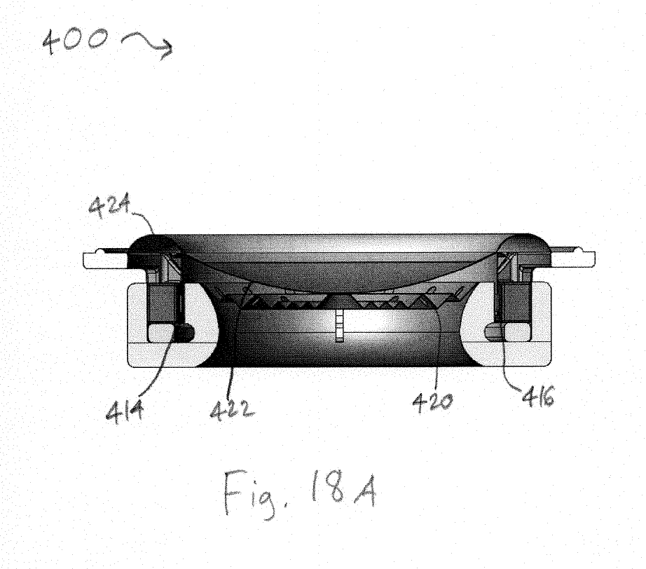

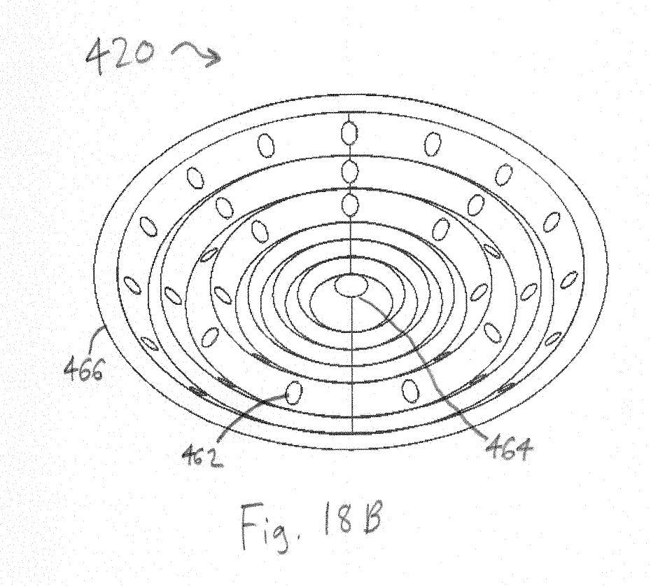

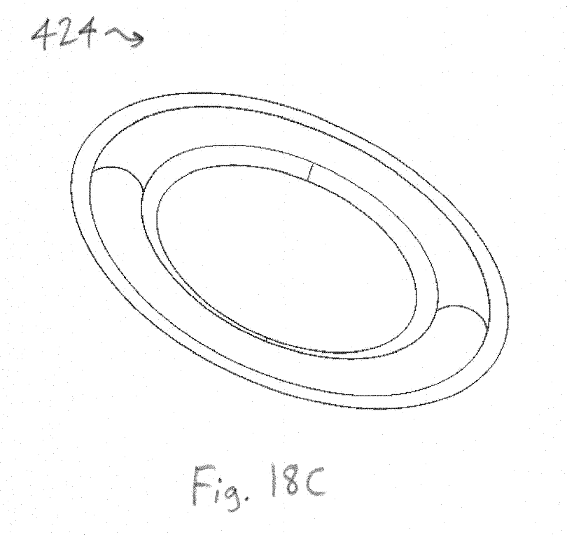

FIG. 18A displays yet another varied design of a speaker driver 400 according to the present disclosure. Speaker driver 400 comprises rear suspension 420, front suspension 424, inverted dome 422, voice coil 414, and bobbin 416. As shown in FIG. 18B, rear suspension 420 comprises vent holes 462, suspension center 464, and suspension edge 466. Rear suspension 420 includes a large number of waves or curves. Also, several vent holes 462 can be on separate rows or waves. The structure of rear suspension 420 can be referred to as a corrugated design. Additionally, FIG. 18C displays the design of front suspension 424.

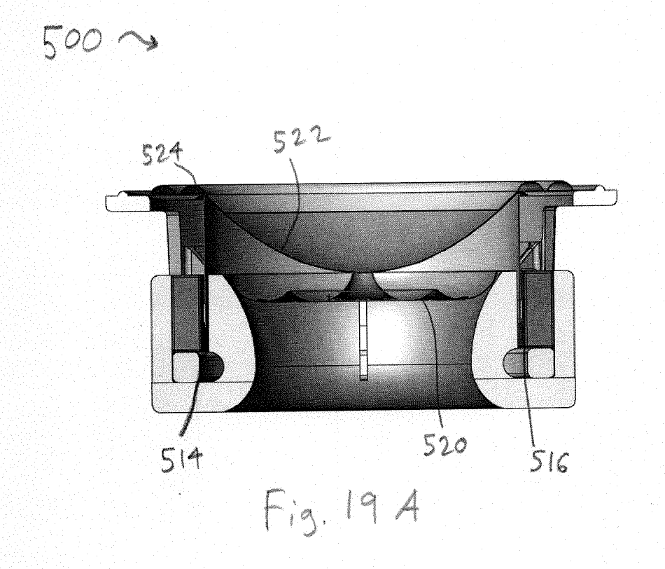

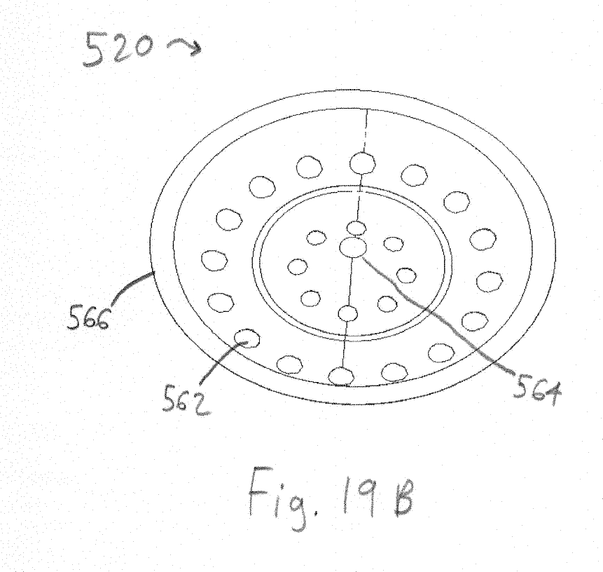

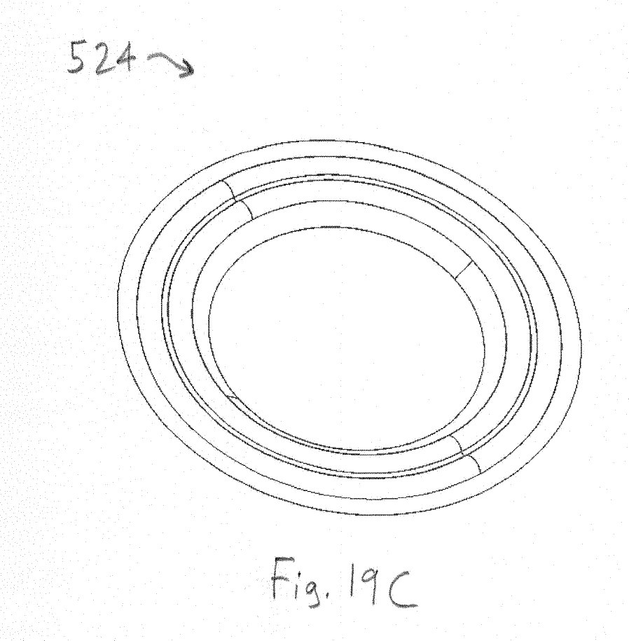

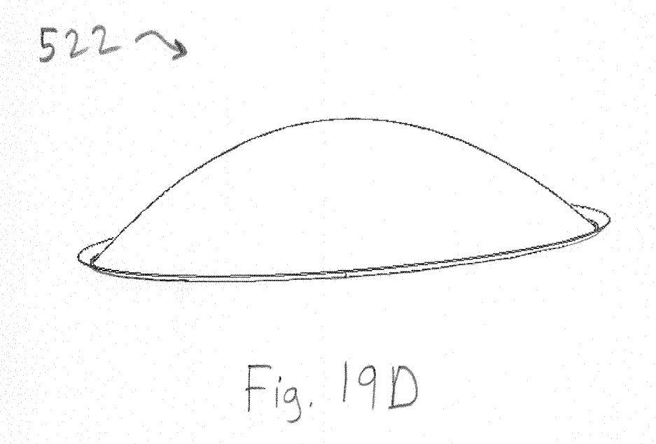

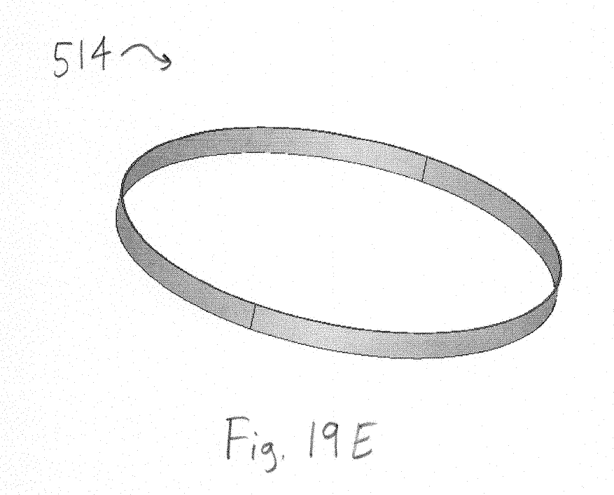

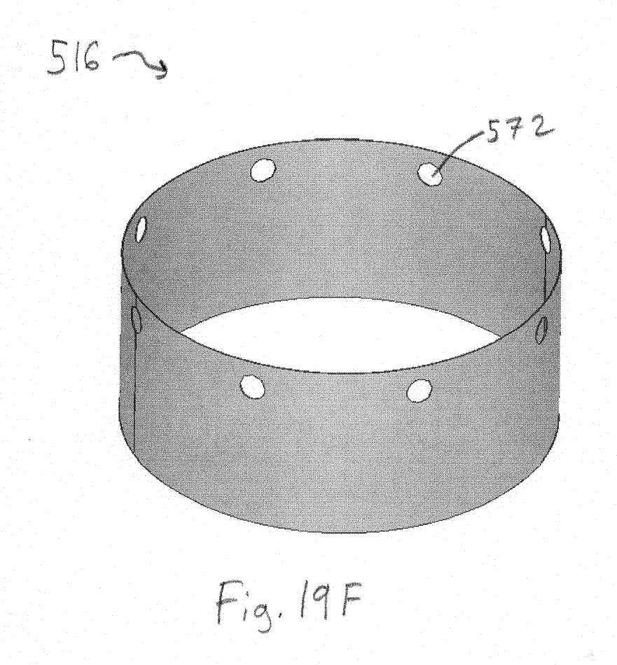

Embodiments according to the present disclosure can comprise further varied component structures. For instance, speaker drivers according to the present disclosure can be used with larger types of speakers. Speaker driver 500 includes one such structure, as displayed in FIG. 19A, wherein components are made longer and/or deeper, which can allow for more excursion and a louder volume output. For example, this type of speaker driver can be used in larger speakers such as 3″, 6.5″, and/or 12″ shallow woofers. As shown in FIG. 19A, speaker driver 500 comprises rear suspension 520, front suspension 524, inverted dome 522, voice coil 514, and bobbin 516, each of which is displayed in FIGS. 19B-19F, respectively.

As shown in FIG. 19B, rear suspension 520 comprises vent holes 562, suspension center 564, and suspension edge 566. Rear suspension 520 can include a deeper suspension center 564 to accommodate the other larger and/or deeper components. FIG. 19C displays front suspension 424. Additionally, FIG. 19D shows inverted dome 522. As mentioned above, inverted dome 522 has a deeper dome structure to allow for more excursion and a louder volume output. FIGS. 19E and 19F display voice coil 514 and bobbin 516, respectively. Bobbin 516 also has a deeper structure and comprises holes 572. It is understood that embodiments according to the present disclosure can include any appropriate component structure.

It is understood that embodiments presented herein are meant to be exemplary. Embodiments of the present disclosure can comprise any combination of compatible features shown in the various figures, and these embodiments should not be limited to those expressly illustrated and discussed.

Although the present disclosure has been described in detail with reference to certain configurations thereof, other versions are possible. Therefore, the spirit and scope of the disclosure should not be limited to the versions described above.

The foregoing is intended to cover all modifications and alternative constructions falling within the spirit and scope of the disclosure as expressed in the appended claims, wherein no portion of the disclosure is intended, expressly or implicitly, to be dedicated to the public domain if not set forth in the claims.

1. A speaker driver, comprising:
a rear suspension comprising a suspension center and a suspension edge;
a dome on said rear suspension, said dome comprising a dome center structure; and
a front suspension on said dome;
wherein said suspension center contacts said dome center structure.

2. The speaker driver of claim 1, wherein said rear suspension at least partially confines the movement of said dome.

3. (canceled)

4. The speaker driver of claim 1, wherein said rear suspension and said front suspension at least partially confine the movement of said dome.

5. The speaker driver of claim 1, further comprising a voice coil on said dome.

6. The speaker driver of claim 5, wherein said rear suspension at least partially confines the movement of said voice coil.

7. The speaker driver of claim 1, wherein said rear suspension comprises one or more vent holes.

8. The speaker driver of claim 7, wherein said one or more vent holes promote air flow within the speaker driver.

9. A speaker driver, comprising:
a rear suspension comprising a suspension center and a suspension edge;
a dome on said rear suspension, said dome comprising a dome center structure;
a front suspension on said dome; and
a base cup on said rear suspension, said base cup comprising at least one base cup gap.

10. The speaker driver of claim 9, further comprising a voice coil on said dome.

11. The speaker driver of claim 10, wherein said voice coil is at least partially within said at least one base cup gap.

12. The speaker driver of claim 9, wherein said suspension edge is on said base cup.

13. The speaker driver of claim 9, wherein said suspension center contacts said dome center structure.

14. The speaker driver of claim 9, wherein said rear suspension and said front suspension at least partially confine the movement of said dome.

15. The speaker driver of claim 10, wherein said rear suspension and said front suspension at least partially confine movement of said voice coil.

16. The speaker driver of claim 9, wherein said rear suspension comprises one or more vent holes.

17. A headphone assembly, comprising:
a speaker driver, comprising:
a rear suspension comprising a suspension center and a suspension edge;
a dome on said rear suspension, said dome comprising a dome center structure; and
a front suspension on said dome;
wherein said suspension center contacts said dome center structure.

18. The headphone assembly of claim 17, wherein said rear suspension and said front suspension at least partially confine the movement of said dome.

19. The headphone assembly of claim 17, further comprising a base cup on said rear suspension, wherein said base cup comprises at least one base cup gap.

20. The headphone assembly of claim 19, further comprising a voice coil on said dome, wherein said voice coil is at least partially within said at least one base cup gap.
